(19) United States
(12) Patent Application Publication
(10) Pub. No.: US 2025/0133041 A1
(43) Pub. Date: Apr. 24, 2025

(54) CONNECTION SYSTEMS AND PROCESSES

(71) Applicant: Wyzr Group, LLC, La Jolla, CA (US)

(72) Inventors: Carolyn Speidel Denholm, La Jolla, CA (US); Joy Teitel, Los Angeles, CA (US)

(73) Assignee: Wyzr Group, LLC, La Jolla, CA (US)

(21) Appl. No.: 18/924,850

(22) Filed: Oct. 23, 2024

Related U.S. Application Data
(60) Provisional application No. 63/592,802, filed on Oct. 24, 2023.

(51) Int. Cl. H04L 51/046; G06Q 50/47; H04L 67/306

(52) U.S. Cl. CPC H04L 51/046; G06Q 50/47; H04L 67/306

(57) ABSTRACT

The presently described systems connect people based on age range, location, shared interests, activities, and health and wellness goals and provide for group communications through a friend blast or carpool request among users of the system.

### BACKGROUND

The inventors have identified a need for a way in which individuals and couples over 40 years of age can meet others like themselves and connect for friendship based on shared interests, activities, health & wellness goals or needs. There is no mobile app currently available for individuals and couples over 40 to meet for platonic relationships and ride-sharing. Further, there is no app that matches individuals and couples based on health and wellness goals.

The present invention addresses these and other related needs in the art.

### SUMMARY

According to embodiments of the present disclosure, a computer implemented method of matching with a person with shared interests is provided, comprising: electronically receiving a plurality of user online friend profiles, each profile comprising traits of a respective user, the traits comprising age, gender, interests, health and wellness goals, and location, and wherein the age comprises an age range rather than a specific age; electronically receiving a first request for identifying one or more of the user online friend profiles, the first request electronically submitted by a first user using a first electronic device; determining a set of potential connections from the plurality of user friend profiles for the first user in response to receiving the first request; causing the display of a graphical representation of a first potential friend connection of the set of potential friend connections to the first user on a graphical user interface of the first electronic device, the first potential friend connection corresponding to a second user; determining that the first user expressed a positive preference indication regarding the first potential friend connection at least by determining that the first user performed an actuation of an accept (e.g., thumbs up) button of the first potential friend connection on the graphical user interface; determining that the second user has expressed a positive preference indication regarding the first user after determining that the first user expressed the positive preference indication regarding the first potential friend connection; enabling initial communication between the first user and the second user in response to determining that both the first user has expressed the positive preference indication regarding the second user and the second user has expressed the positive preference indication regarding the first user; enabling communication concerning establishing a friend blast between the first user and the second user in response to determining that both the first user has expressed the positive preference indication regarding the second user and the second user has expressed the positive preference indication regarding the first user; enabling communication concerning establishing a carpool between the first user and the second user in response to determining that both the first user has expressed the positive preference indication regarding the second user and the second user has expressed the positive preference indication regarding the first user; determining that the first user expressed a negative preference indication regarding a third potential friend connection of the set of potential friend connections by determining that the first user performed an actuation of a decline (e.g., thumbs down) button of the third potential friend connection on the graphical user interface, the third potential friend connection corresponding to a third user; preventing communication between the first user and the third user after determining that the first user has expressed the negative preference indication regarding the third user; determining that the first user expressed a positive preference indication regarding a fourth potential friend connection of the set of potential connections at least by determining that the first user performed an actuation of an accept (e.g., thumbs up) button of the fourth potential friend connection on the graphical user interface, the fourth potential friend connection corresponding to a fourth user; and preventing communication between the first user and the fourth user, if applicable, after determining that the fourth user has expressed a negative preference indication regarding the first user.

Also according to embodiments described herein, the computer implemented methods prevent communication between the first user and the fourth user, if applicable, after determining that the fourth user has expressed a negative preference indication regarding the first user.

Also according to embodiments described herein, the computer implemented methods comprise determining that the first user expressed a positive preference indication regarding a fifth potential friend connection at least by determining that the first user performed an actuation of an accept (e.g., thumbs up) button of the fifth potential friend connection on the graphical user interface, the fifth potential friend connection corresponding to a fifth user; determining that the fifth user has expressed a positive preference indication regarding the first user after determining that the first user expressed the positive preference indication regarding the fifth potential friend connection; determining that the first user expressed a positive preference indication regarding a sixth potential friend connection at least by determining that the first user performed an actuation of an accept (e.g., thumbs up) button of the sixth potential friend connection on the graphical user interface, the sixth potential friend connection corresponding to a sixth user; and determining that the sixth user has expressed a positive preference indication, if applicable, regarding the first user after determining that the first user expressed the positive preference indication regarding the sixth potential friend connection.

Also according to embodiments described herein, the computer implemented methods further comprise enabling communication between the first user and all of the second, fifth and sixth users in response to determining that both the first user has expressed the positive preference indication regarding the second, fifth and sixth users, and the second, fifth and sixth users have expressed the positive preference indication regarding the first user, wherein the communication between the first user and all of the second, fifth and sixth users is by way of a single message sent by the first user simultaneously to the second, fifth and sixth users.

Also according to embodiments described herein, the computer implemented methods further comprise enabling communication concerning establishing the friend blast between the first user and one or more of the second, fifth and sixth users in response to determining that both the first user has expressed the positive preference indication regarding the second, fifth and sixth users, and the second, fifth and sixth users have expressed the positive preference indication regarding the first user, wherein the communication concerning establishing the friend blast request between the first user and all of the second, fifth and sixth users is by way of a single message sent by the first user simultaneously to the second, fifth and sixth users.

Also according to embodiments described herein, the computer implemented methods further comprise enabling communication concerning establishing the carpool request between the first user and one or more of the second, fifth and sixth users in response to determining that both the first user has expressed the positive preference indication regarding the second, fifth and sixth users, and the second, fifth and sixth users have expressed the positive preference indication regarding the first user, wherein the communication concerning establishing the carpool request between the first user and all of the second, fifth and sixth users is by way of a single message sent by the first user simultaneously to the second, fifth and sixth users.

Also according to embodiments described herein, the age range comprises <40 yrs, <50 yrs, 50-64 yrs, 65-74 yrs, >75 yrs.

According to frequently preferred embodiments, the present systems and methods are limited to availability and use by people that are 40 years of age or older. Also, according to less frequent embodiments described herein, the present systems and methods are available and useable by all adults, including those below 40 years of age.

Also according to embodiments described herein, the health and wellness goals are selected from one or more of spiritual, occupational, mindfulness, family, friendship, fun and recreation, health and financial.

Also according to embodiments described herein, the carpool request includes information about an activity, time, date, location, choice of friends of the carpool request origin and/or destination.

Also according to embodiments described herein, the friend blast includes information about a time, date and location, and choice of friends of an activity. Often the activity involves or is related to one or more of the following: wine tasting, movies, book club, dining, shopping, walking, pickleball, day trips, coffee, golf, travel, hobbies, music, beach, hiking, cooking, biking, theatre, gym, and other sports or interests. Also often, the activity involves or is related to one or more of the following: sports, hobbies, fitness, technology, arts and culture, food and cooking, travel, volunteerism, book clubs, faith-based groups, spirituality based groups, health, weight loss, online communities, gaming, and concerts or movies.

According to embodiments described herein, the method further comprises enabling a user to opt out of communication with one or more other user. Often the user is enabled to opt out of communication concerning a friend blast or a carpool request.

Also according to embodiments described herein, the methods and systems are adapted to function on a smartphone, tablet, computer or other computing device.

According to embodiments described herein, a system is provided for matching with one or more person with shared interests and/or health and wellness goals, comprising: a transitory computer having readable instructions stored thereon and configured to: electronically receive a plurality of user online friend profiles, each profile comprising traits of a respective user, the traits comprising individual or couple, age, gender, interests, communities, health and wellness goals, and location, wherein the age comprises an age range; electronically receive a first request for identifying one or more of the user online friend profiles, the first request electronically submitted by a first user using a first electronic device; determine a set of potential connections from the plurality of user friend profiles for the first user in response to receiving the first request; cause the display of a graphical representation of a first potential friend connection of the set of potential friend connections to the first user on a graphical user interface of the first electronic device, the first potential friend connection corresponding to a second user; determine that the first user expressed a positive preference indication regarding the first potential friend connection at least by determining that the first user performed an actuation of an accept button of the first potential friend connection on the graphical user interface; determine that the second user has expressed a positive preference indication regarding the first user after determining that the first user expressed the positive preference indication regarding the first potential friend connection; enable initial communication between the first user and the second user in response to determining that both the first user has expressed the positive preference indication regarding the second user and the second user has expressed the positive preference indication regarding the first user; enable communication concerning establishing a friend blast between the first user and the second user in response to determining that both the first user has expressed the positive preference indication regarding the second user and the second user has expressed the positive preference indication regarding the first user; enable communication concerning establishing a carpool between the first user and the second user in response to determining that both the first user has expressed the positive preference indication regarding the second user and the second user has expressed the positive preference indication regarding the first user; determine that the first user expressed a negative preference indication regarding a third potential friend connection of the set of potential friend connections by determining that the first user performed an actuation of a decline button of the third potential friend connection on the graphical user interface, the third potential friend connection corresponding to a third user; prevent communication between the first user and the third user after determining that the first user has expressed the negative preference indication regarding the third user; determine that the first user expressed a positive preference indication regarding a fourth potential friend connection of the set of potential connections at least by determining that the first user performed an actuation of an accept button up of the fourth potential friend connection on the graphical user interface, the fourth potential friend connection corresponding to a fourth user; and prevent communication between the first user and the fourth user, if applicable, after determining that the fourth user has expressed a negative preference indication regarding the first user.

These and other embodiments, features, and advantages will become apparent to those skilled in the art when taken with reference to the following more detailed description of various exemplary embodiments of the present disclosure in conjunction with the accompanying drawings.

### BRIEF DESCRIPTION OF THE DRAWINGS

The skilled person in the art will understand that the drawings, described below, are for illustration purposes only.

FIG. 1 depicts an exemplary user interface utilized for sending a friend blast and/or a carpool request by a user.

FIG. 2 depicts an exemplary user interface utilized for establishing the type of activity as part of a friend blast.

FIG. 3 depicts an exemplary user interface utilized for setting a time and date for an activity as part of a friend blast.

FIG. 4 depicts an exemplary user interface utilized for establishing the location for the activity as part of a friend blast.

FIG. 5 depicts an exemplary user interface utilized for choosing which friends will receive the friend blast.

FIG. 6 depicts an exemplary user interface utilized by users of the system that receive a friend blast to accept or decline participation in the activity of the friend blast.

FIG. 7 depicts an exemplary user interface utilized for establishing the type of activity as part of a carpool request.

FIG. 8 depicts an exemplary user interface utilized for setting a time and date for an activity as part of a carpool request. The location/destination/origin of the carpool request may also be identified in this or another screen.

FIG. 9 depicts an exemplary user interface utilized for establishing the location for the carpool request.

FIG. 10 depicts an exemplary user interface utilized for choosing which friends will receive the carpool request.

FIG. 11 depicts an exemplary user interface showing the details of the carpool request and permitting users of the system to accept or decline the carpool request.

FIGS. 12A-12H depict an exemplary user interface showing where a user of the system can establish or edit a plurality of specific personal health and wellness goals.

FIGS. 13A-13D depict an embodiment of profiles of exemplary users of the presently described systems and methods. FIGS. 13A and 13B depict a user profile of a single woman. FIGS. 13C and 13D depict a user profile of a couple.

### DETAILED DESCRIPTION

For clarity of disclosure, and not by way of limitation, the detailed description of the invention is divided into the subsections that follow.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in the patents, applications, published applications and other publications that are herein incorporated by reference, the definition set forth in this section prevails over the definition that is incorporated herein by reference.

As used herein, “a” or “an” means “at least one” or “one or more.”

As used herein, the term “and/or” may mean “and,” it may mean “or,” it may mean “exclusive-or,” it may mean “one,” it may mean “some, but not all,” it may mean “neither,” and/or it may mean “both.”

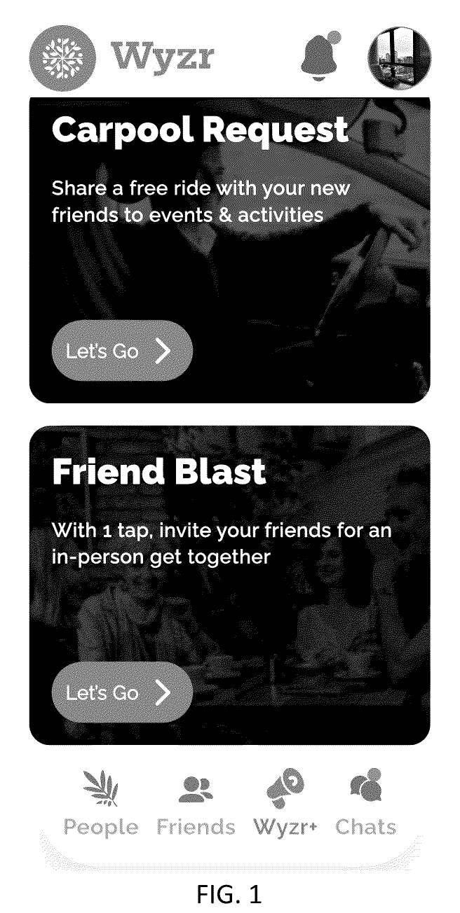

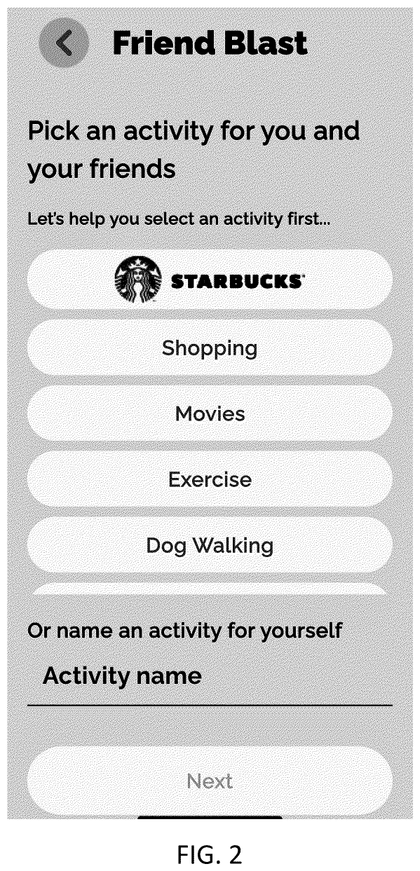

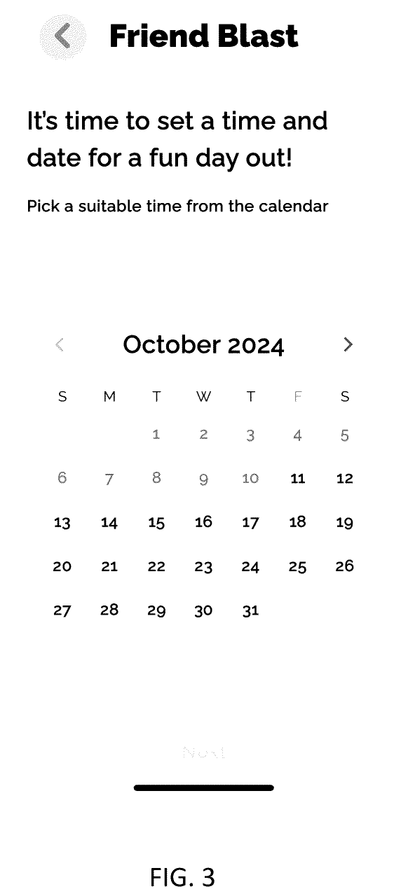

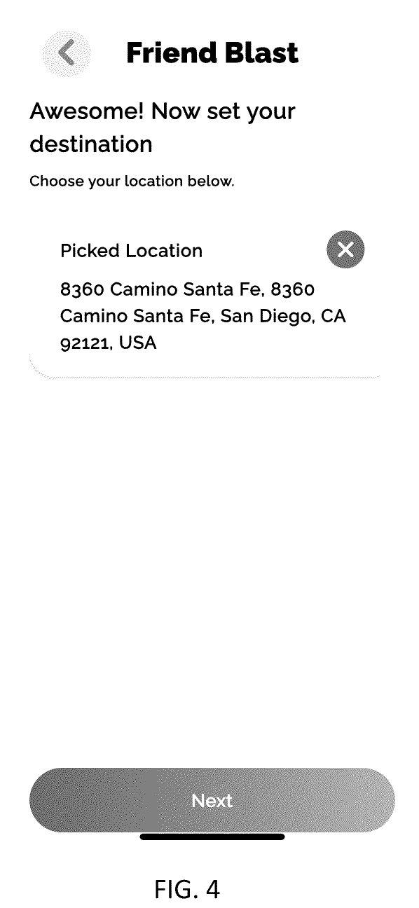

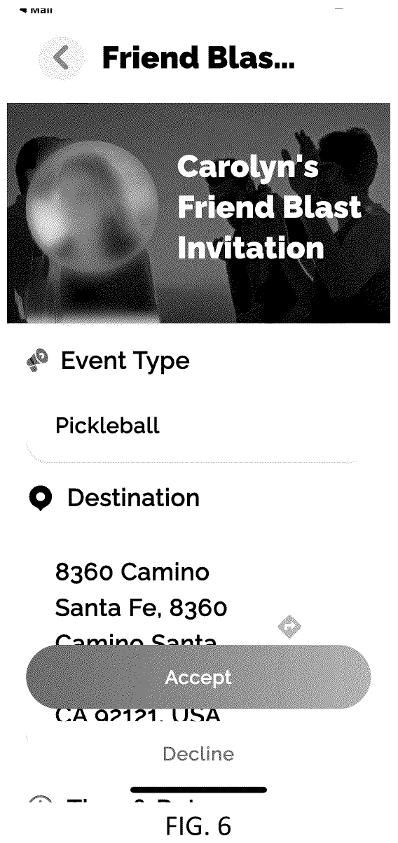

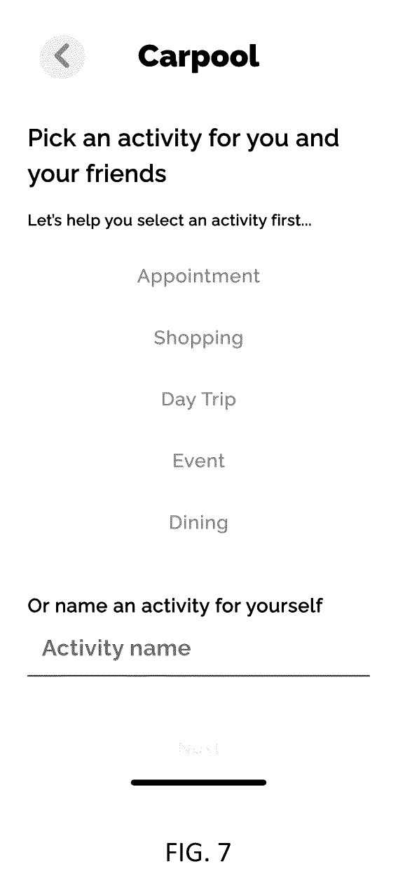

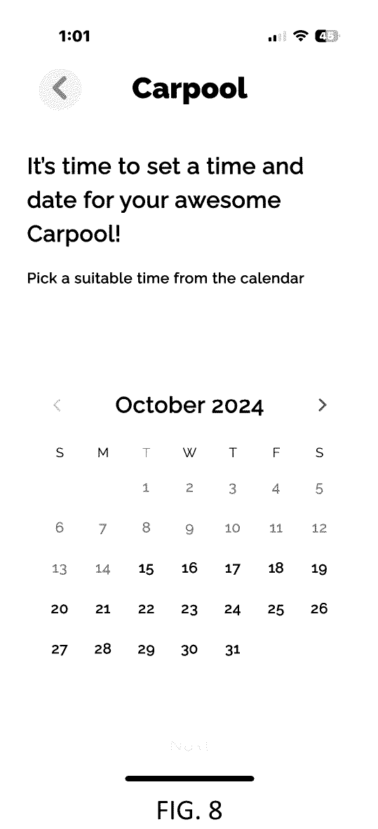

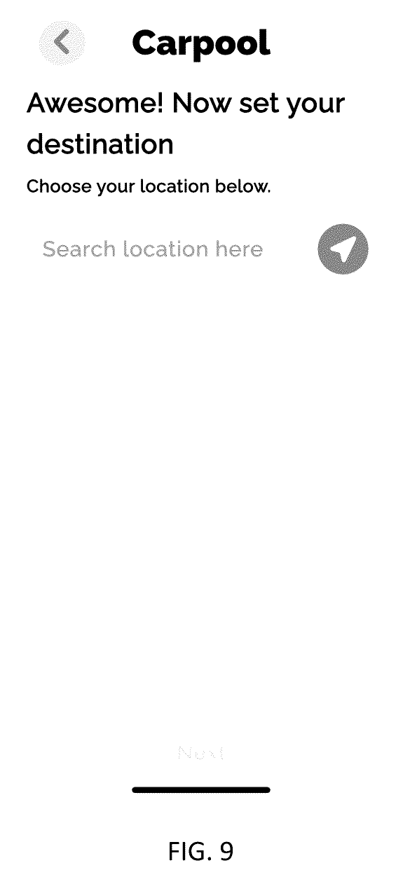

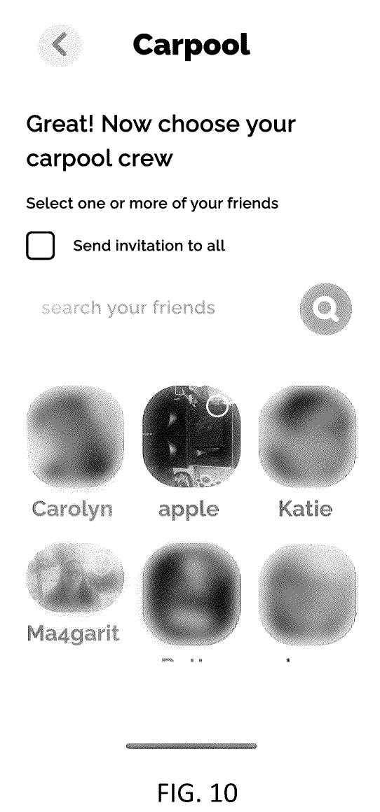

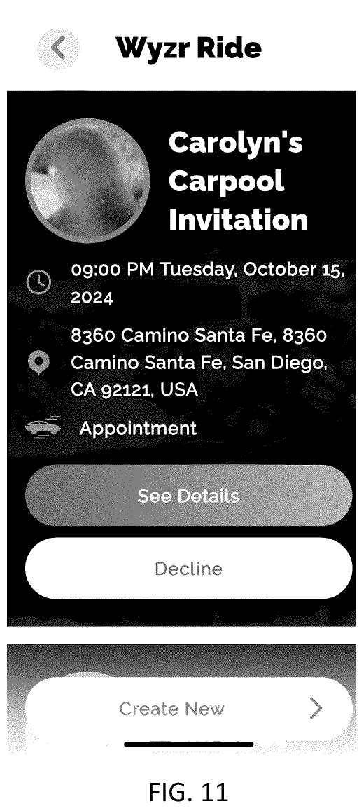

The presently described systems match people based on age range (though in most embodiments the exact age is not revealed), location, shared interests, communities, activities, and health and wellness goals. These systems provide a smarter, safer activity-based friendship application that connects adults, particularly but not limited to those 30 plus or 40 plus years old, with shared interests online and in-person. During an exemplary employment of the system, a group of friends is created in the application for each user based on actions of that user to select among presented profiles of potential friends, and this group of friends is instantly available for activity (FIG. 1-6) and/or carpooling (FIGS. 1, 7-11) options. The application is adapted to locate non-romantic matches for a user. A variety of options are therefore available to users of the system that heretofore were not available for older adults that otherwise may not have a large social circle. In one example of the use of the system, the user builds a friend network using the system and then has available friends instantly available to join them for example, last minute event tickets when the user's significant other is not available or not interested in the event, a spontaneous meetup for drinks or coffee, or a Sunday morning hike. The options for activities are limitless, even though the system may include a variety of pre-established activities. Users of the system can enter their own specific activities, communities, and health and wellness goals.

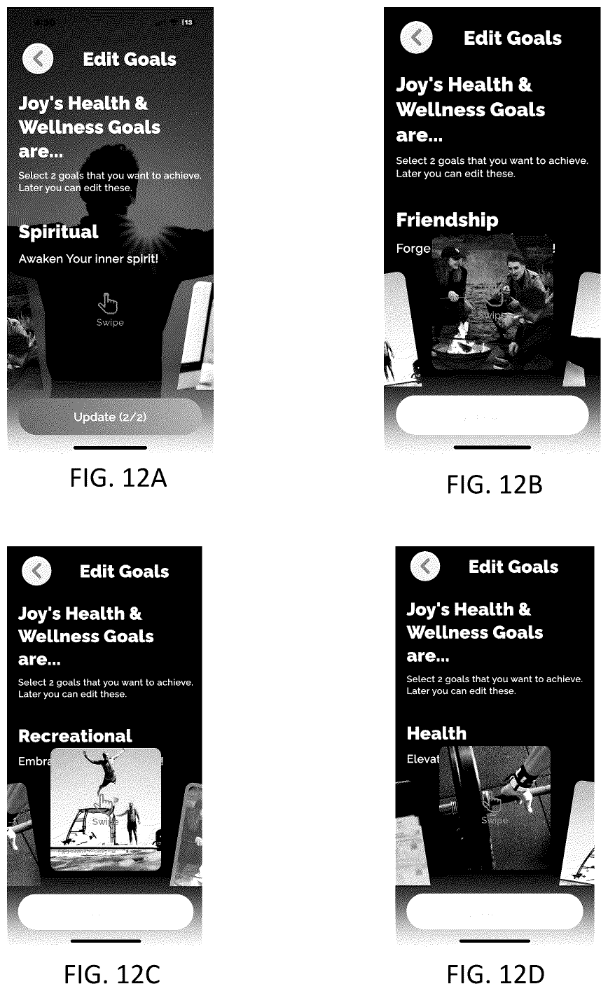

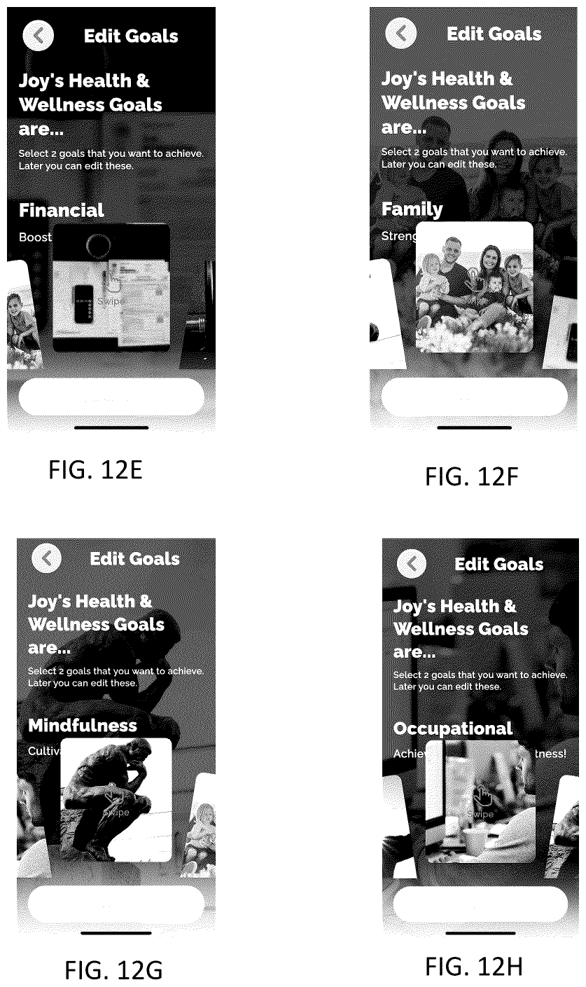

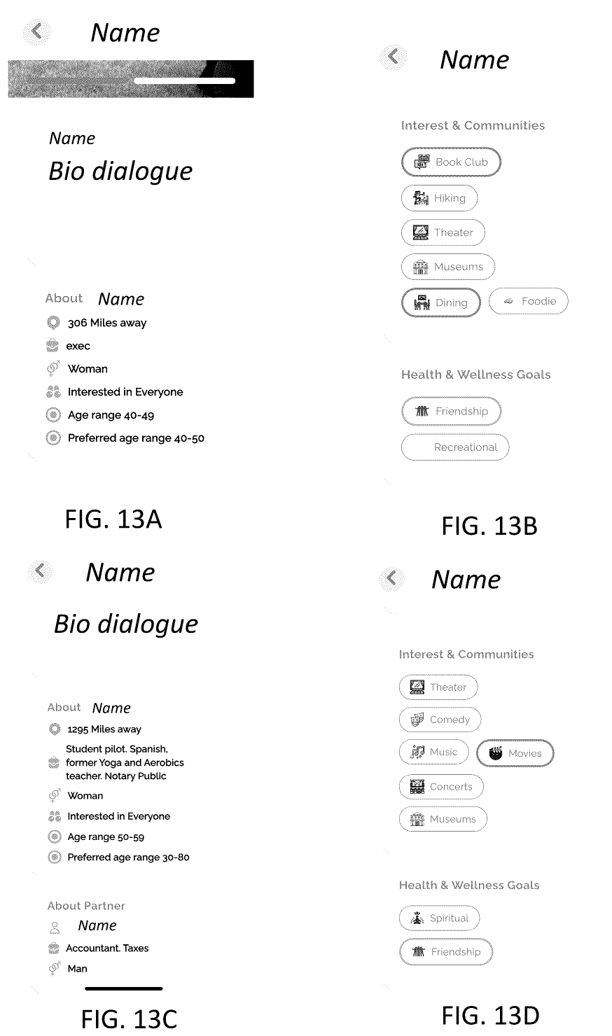

In practice a user downloads a mobile application embodying and operating the presently described systems and methods, each executed in a computer implemented method. The user then signs in with Google, Apple or using a phone number and enters a name. If the user is a couple, then the names are entered. If they are in a couple or other relationship, they specify the nature of the relationship (e.g., romantic or just friends). The user then enters, age, occupation, gender, and bio description—what you are looking for. With regard to age, the user inputs their age range, not their exact age, based on a number of presented age range options. Age range options include, for example, <40 yrs, <50 yrs, 50-64 yrs, 65-74 yrs, >75 yrs. The user may also select a preferred age range that they will consider for friends on the system. If the user is representative of a couple, there is an option to include similar information of both people in the couple. With regard to gender, the user also selects gender identification as male, female, non-binary, among other potential options. The user then selects interests for use of the system (e.g., carpool, wine tasting, movies, book club, dining, shopping, walking, golf, travel, music, beach, hiking, cooking, biking, theatre, gym, other sports or interests, etc.). And the user selects health and wellness goals and can add profile pictures. With regard to health and wellness goals, the user can specify the areas of health and wellness they have interest in and are interested in achieving goals in the selected areas (FIGS. 12A-12H). At this point in an exemplary account creation or previously, the user can enable their location based on location features of their mobile device. FIGS. 13A-13 depict two exemplary profiles, including exemplary single person (FIGS. 13A-13B) and couple (FIGS. 13C-13D). As shown, in exemplary embodiments, each category including personal information such as location, employment/career, gender, other user interest group, age range, preferred age range, interests & communities, and health & wellness goals often includes a stylized icon that is representative of the category for that information. Exemplary icons are shown in FIGS. 13A-13D.

There is also an option in the present systems for the user to verify their identification to achieve an identification verification badge, which may be optional. In this process, the user inputs personal information and has their identity verified to create a safe community (e.g., using government documents and a live selfie photo). The user may also select to receive notifications or disable notifications. Once matches appear, the user can select matches and begin a chat with other users that they have been matched with. The user may also search for profiles based on distance from enabled location or entered location, and can select age ranges, gender and couples vs. singles to search for potential matches.

The present systems and methods take account of all these selection options to build a profile for the user which is used to connect that user with other users of the systems and methods with similar or identical interests and characteristics. In certain embodiments only users with similar or identical interests, and characteristics such age range (not exact age), gender, location, single or couple, interests, communities, and health & wellness goals, as entered by user and accounted for by an algorithm or computerized data alignment selection, are displayed to a user seeking to add friends using the present systems. When profiles appear, they may be viewed by the user in a grid or by swiping left or right. The user can tap an indicator button such as a thumbs up button to match with the selected user and a thumbs down to dislike. The presently described methods and systems are adapted to be resident and function on a smartphone, tablet, computer or other computing device, with access to cloud based resources as required for functionality and data access.

According to the presently described systems, an algorithm is used to select among registered users to display friend options to the user for them to select based, for example, on interests and characteristics of other users and/or a pre-selected thumbs up or thumbs down criteria. As noted, a selection of interests and characteristics of other users includes two or more (including all) of age range (not exact age), gender, location, single or couple, interests, communities, and health & wellness goals of other users. In one example, the first user selects another user with a thumbs up of a second user. If that second user selects the first user's profile with a thumbs-up then a connection is established between user 1 and user 2. At this point user 2 is added to user 1's pool of friends and vice versa. User 1 and user 2 then can connect with a friend blast and/or carpool request. Additional users can be added to each users' pool of friends, which are individual pools of friends that may be different for each user. When a pool of other users is created by each user, this pool is often individual to the specific user of the system based on their preferences. In certain embodiments, a user of the system can select to see unfriended users based on shared interest in a selection of one or more interests and/or characteristics such as communities, health & wellness goals, age range and location. Also in certain embodiments, a user of the system can select to see a sub-selection of their friend pool based on shared interest in a selection of one or more interests and/or characteristics such as communities, health & wellness goals, age range and location.

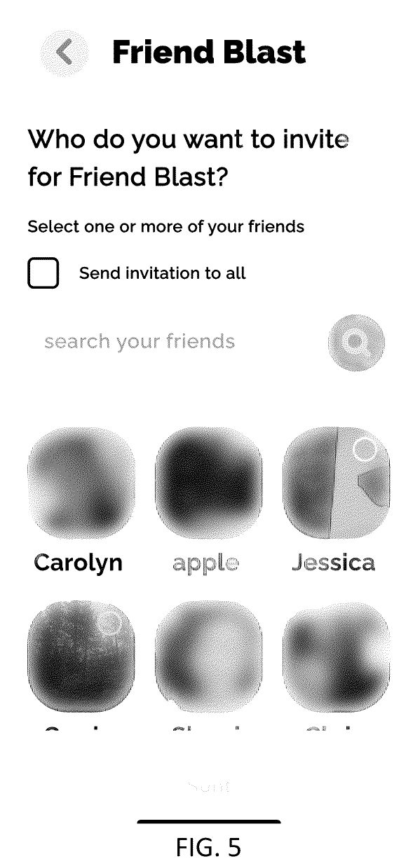

As another example, when a user is interested in a carpool, the user may invite all or some of their friends to share a ride. As a further example, in certain embodiments when a user sends a friend blast concerning a particular activity (shopping, coffee, etc.), all of that user's friends are shown (FIG. 5) as options of friends to select for the friend blast.

The presently described systems provide users with the best possible connections by matching them based upon shared interests, activities, communities, health & wellness goals, age range and location. In certain embodiments, if a user desires to remove a friend from their pool of friends, that friend can be selected and removed from the pool of friends by the user.

Interests, activities and/or communities may include, for example, interests such as carpool, wine tasting, movies, book club, dining, shopping, walking, golf, travel, hobbies, music, beach, hiking, cooking, biking, theatre, gym, politics, kids/parenting, spirituality, religious, finance, real estate, academic or scientific research disciplines, other sports or interests. In certain embodiments, interests, activities and communities are separated and selectable in the present systems by general topics such as sports (e.g., football, basketball, baseball, soccer, and other sports leagues and fandoms), hobbies (e.g., gardening, photography, knitting, woodworking, and DIY projects), fitness (e.g., running, yoga, cycling groups, and other fitness communities), technology (e.g., gaming communities, and VR), arts and culture (e.g., art clubs, theater groups, and concerts), food and cooking (e.g., culinary classes, dining, and local cooking clubs), travel (e.g., travel groups, adventure clubs, and cultural exchange programs), volunteerism (e.g., community service organizations, environmental groups, and non-profits), book clubs, faith-based groups, spirituality based groups, parenting (e.g., support groups for new parents, parenting classes, and local playgroups), online communities (e.g., social media groups, forums, and platforms like Reddit or Discord), environmental activism (e.g., groups focused on sustainability and conservation), gaming (e.g., board game clubs, tabletop RPG groups, and video game communities), history and heritage (e.g., historical societies, genealogy clubs, and cultural heritage groups). These categories are exemplary only and not intended to be limiting.

The algorithm and options utilized to create matches in the present systems are designed around forming friendships and are not adapted to identify romantic partners. Specifically, the present systems and applications do not gather information used to identify romantic partners such as, for example, height, sexual orientation, hair color or other physical attributes, body style or weight, type of relationship that is being sought, etc. Thus, the algorithm and options utilized to create matches in the present systems are not adapted for identifying romantic partners. Moreover, the algorithm and options utilized to create matches in the present systems are adapted to connect adults in their 30s, 40s, 50s, 60s and older for activities and friendship, and they are not adapted to account for the preferences and lifestyles of teens or young adults.

The present systems also utilize a music-based user interface that includes in one example, playing a portion of a song (e.g., “Thank You for Being a Friend” by Andrew Gold) as the user opens or begins to use the application. Other music or segments of music may be utilized as well.

The presently described systems also match friends who want to “Carpool” for any of a variety of activities, including for example, shopping, activities, appointments or day trips. In one exemplary embodiment of this process a user interacts with the user interface (FIGS. 1, 7-11) to indicate that they would like to see if any (or all) of their friends on the application are available for a carpool to a specific location at a specific time and date, with an option to identify the reason for the carpool request. Carpool requests are sent via a chat function in the application, where users that receive the friend blast can respond and coordinate in the chat. Friends can then respond to indicate whether they are available and willing to carpool, identify drivers, etc., and message each other to physically meet and participate in the carpool activity. This allows members to select their date, time and destination and ride together for free (to/from a sporting event, concert, or shopping). Carpooling has a positive impact on the environment and saves money for the users. The carpooling option also provides for a safe environment for users to find or provide a ride for free with people they know and share a common interest. This is useful for users that do not want to take their own vehicle but want the environment and cost savings of a carpool but want to do it only with pre-selected friends that have matched with them based on the methods and algorithms described herein, rather than being forced to ride with strangers. According to embodiments described herein, a user can opt out of communication concerning a carpool request at their discretion even if the communication is among established friends, without losing the connection to other friends.

The presently described systems also provide for the ability of users of the system to send “friend blasts” to find out which of their friends in their established pool of friends are available to get together (in person or virtually). In one exemplary embodiment of this process a user interacts with the user interface (FIGS. 1-6) to indicate that they would like to see if any (or all) of their friends on the application are available for a specific activity at a specific time, date and location. Friend blasts are sent via a chat function in the application, where users that receive the friend blast can respond and coordinate in the chat. Friends can then respond to indicate whether they are available and willing to participate in the activity (including an option for a carpool (FIGS. 1, 7-11) as described above), and message each other to physically meet and participate in the activity. With a friend blast, members can make scheduled or impromptu plans with one or more of their friends. Members can organize gatherings (like a game of pickleball or trivia night), or simply catch up with friends effortlessly. According to embodiments described herein, a user can opt out of communication concerning a friend blast at their discretion even if the communication is among established friends, without losing the connection to other friends.

The presently described systems also provide for the ability of users of the system to connect to achieve mutual health goals, including physical, mental, financial and spiritual. In one exemplary embodiment of this process a user interacts with the user interface to indicate what aspects of health and wellness the user is interested in exploring as a goal or interest (FIGS. 12A-12H). In the examples provided, spiritual, occupational, mindfulness, family, friendship, recreation, health and financial health and wellness options are provided. An important aspect of this is that the user is interested in achieving goals with regard to the selection of health and wellness options.

In exemplary embodiments, when using the system to establish or edit health and wellness goals, the user interface displays the larger health and wellness goal categories in a wheel that can be rotated by the user to select a specific health and wellness goal by swiping the wheel around to the left or right. In certain other embodiments, when using the system to establish or edit health and wellness goals, the user interface displays a list of the larger health and wellness goal categories, where one or more health and wellness goals can be selected by the user. When a desired specific health and wellness goal is identified on the wheel, it can be selected to establish it as a goal. In certain embodiments 2 different health and wellness goals are established. In other embodiments, between one to 8 different health and wellness goals are established. As noted, the larger health and wellness goal categories often include, for example, spiritual, occupational, mindfulness, family, friendship, recreation, health and financial health and wellness.

Health & wellness goal categories are often listed in the system as including, for example, spiritual, occupational, mindfulness, family, friendship, recreation, health and/or financial. There are a variety of sub-goals within each of these categories that may be listed or selectable for each specific larger health and wellness goal selection in the present systems. It may be left to the user to interpret each category as an area their particular health and wellness goals lie.

Occupational goals may include or relate to, for example, skill development, networking, goal setting, work-life balance, mentorship, stress management, job rotation, job duty expansion, creating or seeking a positive work environment, working remotely, continuous learning, occupational/value adaptation, and celebrating achievements. These are exemplary only and not intended to be limiting.

Mindfulness goals may include or relate to, for example, mindful breathing, meditation, body awareness, connections with the outdoors and nature, journaling, practicing gratitude, adjusting activity and work schedules, mind-body movement practices, compassion and empathy practices, mindfulness reminders, guided mindfulness applications and workshops. These are exemplary only and not intended to be limiting.

Spiritual goals may include, for example, meditation and mindfulness, connection with nature, journaling, prayer, attending spiritual gatherings, volunteering, practicing gratitude, breathwork, creative expression, exploring expanded beliefs and believe structures, establishing spiritual rituals, engagement with a spiritual community, spirituality retreats, mind-body movement practices such as yoga or tai chi. These are exemplary only and not intended to be limiting.

Family health and wellness goals may include or relate to, for example, family meetings, shared activities, healthy eating, exercising together, quality time, open communications, setting boundaries, practicing gratitude, volunteering together, creating traditions, supporting others' interests, mindfulness practice, limiting screen time, conflict resolution and family health check-ups. These are exemplary only and not intended to be limiting.

Friendship health and wellness goals may include or relate to, for example, regular check-ins, planning fun activities, practicing active listening, expressing gratitude, creating rituals, engaging in group activities, sharing goals, limiting toxicity, celebrating milestones, practicing vulnerability, participating in community service, encouraging self-care, having honest conversations, and creating a positive environment. These are exemplary only and not intended to be limiting.

Financial health and wellness may include or relate to, for example, budgeting, building an emergency fund, debt management, savings goals, investing, financial education, tracking spending, reviewing the need for existing subscriptions, seeking professional advice, retirement planning, diversifying income streams, review of financial goals, teaching financial literacy, staying informed, and mindful spending. These are exemplary only and not intended to be limiting.

Recreation goals may include or relate to, for example, exploring hobbies, outdoor activities, joining a sports league, game nights, attending events, travel or exploration, taking classes, volunteering for fun, mindfulness in recreation, creating a bucket list, trying new fitness classes, attending workshops, or creating a fun routine. These are exemplary only and not intended to be limiting.

Health goals may include or relate to, for example: physical health, sleep, mental health, emotional well-being, habit breaking, limiting stress, adjusting physical activity, improving nutritional, reducing or eliminating the consumption or use of specific items, adjusting or reducing prescription drugs, building strength, obtaining regular check-ups or screenings, preventative care, enhancing flexibility, becoming part of a community with aligned interests and goals, managing chronic conditions, and self-care. These are exemplary only and not intended to be limiting.

Health and wellness goals are intended to have a broad reach in the present systems. While specific categories of health or wellness goals are included in the system, they are intended to encompass a variety of health or wellness goals of the users of the system.

The presently described systems also provide for enhanced identity verification of users to ensure safety of the user population. Government identification documents and physical identifiers are used in the process of identity verification.

The presently describe systems also provide access to curated events including local events, coffee connect friendship networking, virtual events, free events, paid events, health & wellness games and challenges, trivia games, and fun and informative, for example, from celebrities and/or experts on friendship, online safety, health & wellness and more.

The present systems make it easy to find real connections and have new experiences in the digital age—it's a solution for adults later in life to enhance their social lives and stay engaged.

The present systems establish a particular community of mature individuals having interest in making connections with other mature users. In that regard, there is at least one common interest among all users. As such, in certain embodiments, the present systems also provide for system-wide, location based, or community-based friend blasts by the system operators to invite all or a selection of users (e.g., based on interests and/or characteristics such as communities, health & wellness goals, age range and location) to an event or activity. Similarly, in certain embodiments, the present systems also provide for system-wide, location based, or community-based friend blasts by one or more user to invite all or a selection of users (e.g., based on interests and/or characteristics such as communities, health & wellness goals, age range and location) to an event or activity. Such events or activities will often bring together users of the system that are not yet in the same pool of friends.

As noted, the present systems are not established to identify romantic connections with other users. The present systems as presently contemplated do not include a public blogging and/or social media option or linkage to public blogs or social media applications or outlets.

Other features and advantages of the invention will be apparent from the detailed description, and from the claims.

We claim:

1. A computer implemented method of matching with one or more person with shared interests and/or health and wellness goals, comprising:
electronically receiving a plurality of user online friend profiles, each profile comprising traits of a respective user, the traits comprising individual or couple, age, gender, interests, communities, health and wellness goals, and location, wherein the age comprises an age range;
electronically receiving a first request for identifying one or more of the user online friend profiles, the first request electronically submitted by a first user using a first electronic device;
determining a set of potential connections from the plurality of user friend profiles for the first user in response to receiving the first request;
causing the display of a graphical representation of a first potential friend connection of the set of potential friend connections to the first user on a graphical user interface of the first electronic device, the first potential friend connection corresponding to a second user;
determining that the first user expressed a positive preference indication regarding the first potential friend connection at least by determining that the first user performed an actuation of an accept button of the first potential friend connection on the graphical user interface;
determining that the second user has expressed a positive preference indication regarding the first user after determining that the first user expressed the positive preference indication regarding the first potential friend connection;
enabling initial communication between the first user and the second user in response to determining that both the first user has expressed the positive preference indication regarding the second user and the second user has expressed the positive preference indication regarding the first user;
enabling communication concerning establishing a friend blast between the first user and the second user in response to determining that both the first user has expressed the positive preference indication regarding the second user and the second user has expressed the positive preference indication regarding the first user;
enabling communication concerning establishing a carpool between the first user and the second user in response to determining that both the first user has expressed the positive preference indication regarding the second user and the second user has expressed the positive preference indication regarding the first user;
determining that the first user expressed a negative preference indication regarding a third potential friend connection of the set of potential friend connections by determining that the first user performed an actuation of a decline button of the third potential friend connection on the graphical user interface, the third potential friend connection corresponding to a third user;
preventing communication between the first user and the third user after determining that the first user has expressed the negative preference indication regarding the third user;
determining that the first user expressed a positive preference indication regarding a fourth potential friend connection of the set of potential connections at least by determining that the first user performed an actuation of an accept button up of the fourth potential friend connection on the graphical user interface, the fourth potential friend connection corresponding to a fourth user; and
preventing communication between the first user and the fourth user, if applicable, after determining that the fourth user has expressed a negative preference indication regarding the first user.

2. The computer implemented method of claim 1, further comprising
determining that the first user expressed a positive preference indication regarding a fifth potential friend connection at least by determining that the first user performed an actuation of an accept button of the fifth potential friend connection on the graphical user interface, the fifth potential friend connection corresponding to a fifth user;
determining that the fifth user has expressed a positive preference indication regarding the first user after determining that the first user expressed the positive preference indication regarding the fifth potential friend connection;
determining that the first user expressed a positive preference indication regarding a sixth potential friend connection at least by determining that the first user performed an actuation of an accept button of the sixth potential friend connection on the graphical user interface, the sixth potential friend connection corresponding to a sixth user; and
determining that the sixth user has expressed a positive preference indication, if applicable, regarding the first user after determining that the first user expressed the positive preference indication regarding the sixth potential friend connection.

3. The computer implemented method of claim 2, further comprising enabling communication between the first user and all of the second, fifth and sixth users in response to determining that both the first user has expressed the positive preference indication regarding the second, fifth and sixth users, and the second, fifth and sixth users have expressed the positive preference indication regarding the first user, wherein the communication between the first user and all of the second, fifth and sixth users is by way of a single message sent by the first user simultaneously to the second, fifth and sixth users.

4. The computer implemented method of claim 2, further comprising enabling communication concerning establishing the carpool request between the first user and one or more of the second, fifth and sixth users in response to determining that both the first user has expressed the positive preference indication regarding the second, fifth and sixth users, and the second, fifth and sixth users have expressed the positive preference indication regarding the first user, wherein the communication concerning establishing the carpool request between the first user and all of the second, fifth and sixth users is by way of a single message sent by the first user simultaneously to the second, fifth and sixth users.

5. The computer implemented method of claim 2, further comprising enabling communication concerning establishing the friend blast between the first user and one or more of the second, fifth and sixth users in response to determining that both the first user has expressed the positive preference indication regarding the second, fifth and sixth users, and the second, fifth and sixth users have expressed the positive preference indication regarding the first user, wherein the communication concerning establishing the friend blast request between the first user and all of the second, fifth and sixth users is by way of a single message sent by the first user simultaneously to the second, fifth and sixth users.

6. The computer implemented method of claim 1, wherein the age range comprises <30 yrs, <40 yrs, <50 yrs, 50-64 yrs, 65-74 yrs, >75 yrs.

7. The computer implemented method of claim 1, wherein the age range comprises <50 yrs, 50-64 yrs, 65-74 yrs, >75 yrs.

8. The computer implemented method of claim 1, wherein the health and wellness goals are selected from one or more of spiritual, occupational, mindfulness, family, friendship, fun and recreation, health and financial.

9. The computer implemented method of claim 5, wherein the carpool request includes information about a time, date and location of the carpool request origin and/or destination.

10. The computer implemented method of claim 6, wherein the friend blast includes information about a time, date and location of an activity.

11. The computer implemented method of claim 10, wherein the activity involves or is related to one or more of the following: wine tasting, travel, beach, concerts, movies, book club, dining, shopping, walking, golf, travel, hobbies, music, beach, hiking, cooking, biking, theatre, gym, politics, kids/parenting, spirituality, religious, finance, real estate, and other sports or interests.

12. The computer implemented method of claim 10, wherein the activity involves or is related to one or more of the following: sports, hobbies, fitness, technology, arts and culture, food and cooking, travel, volunteerism, book clubs, faith-based groups, spirituality based groups, parenting, online communities, environmental activism, gaming, and history and heritage.

13. The computer implemented method of claim 1, further comprising enabling a user to opt out of communication with one or more other user.

14. The computer implemented method of claim 1, wherein the user is enabled to opt out of communication concerning a friend blast or a carpool request.

15. The computer implemented method of claim 1, wherein the method is adapted to function on a smartphone, tablet, computer or other computing device.

16. A system for matching with one or more person with shared interests and/or health and wellness goals, comprising: a transitory computer having readable instructions stored thereon and configured to:
electronically receive a plurality of user online friend profiles, each profile comprising traits of a respective user, the traits comprising individual or couple, age, gender, interests, communities, health and wellness goals, and location, wherein the age comprises an age range;
electronically receive a first request for identifying one or more of the user online friend profiles, the first request electronically submitted by a first user using a first electronic device;
determine a set of potential connections from the plurality of user friend profiles for the first user in response to receiving the first request;
cause the display of a graphical representation of a first potential friend connection of the set of potential friend connections to the first user on a graphical user interface of the first electronic device, the first potential friend connection corresponding to a second user;
determine that the first user expressed a positive preference indication regarding the first potential friend connection at least by determining that the first user performed an actuation of an accept button of the first potential friend connection on the graphical user interface;
determine that the second user has expressed a positive preference indication regarding the first user after determining that the first user expressed the positive preference indication regarding the first potential friend connection;
enable initial communication between the first user and the second user in response to determining that both the first user has expressed the positive preference indication regarding the second user and the second user has expressed the positive preference indication regarding the first user;
enable communication concerning establishing a friend blast between the first user and the second user in response to determining that both the first user has expressed the positive preference indication regarding the second user and the second user has expressed the positive preference indication regarding the first user;
enable communication concerning establishing a carpool between the first user and the second user in response to determining that both the first user has expressed the positive preference indication regarding the second user and the second user has expressed the positive preference indication regarding the first user;
determine that the first user expressed a negative preference indication regarding a third potential friend connection of the set of potential friend connections by determining that the first user performed an actuation of a decline button of the third potential friend connection on the graphical user interface, the third potential friend connection corresponding to a third user;
prevent communication between the first user and the third user after determining that the first user has expressed the negative preference indication regarding the third user;
determine that the first user expressed a positive preference indication regarding a fourth potential friend connection of the set of potential connections at least by determining that the first user performed an actuation of an accept button up of the fourth potential friend connection on the graphical user interface, the fourth potential friend connection corresponding to a fourth user; and
prevent communication between the first user and the fourth user, if applicable, after determining that the fourth user has expressed a negative preference indication regarding the first user.
